(19) United States
(12) Patent Application Publication
(10) Pub. No.: US 2008/0319732 A1
(43) Pub. Date: Dec. 25, 2008

(54) Serial channel emulator

(76) Inventor: Jeffrey S. Farnsworth, Phoenix, AZ (US)

Correspondence Address: JACKSON WALKER LLP, 901 MAIN STREET, SUITE 6000, DALLAS, TX, 75202-3797, US

(21) Appl. No.: 11/821,400

(22) Filed: Jun. 22, 2007

(51) Int. Cl. G06F 9/455

(52) U.S. Cl. 703/25

(57) ABSTRACT

A serial channel emulator adapted to react and respond to an electronic device in such a way that the electronic device will allow a third party power adapter containing the serial channel emulator to power the electronic device is presented. The serial channel emulator utilizes a processing unit to emulate a serial channel in the third party power adapter by receiving data from the electronic device, making decisions based upon the data, and delivering an appropriate response to the electronic device in order to allow the third party power adapter to be used instead of a proprietary device. Once the electronic device has established communication with the power adapter and received the appropriate response, the electronic device would allow the third party power adapter to power and/or charge the electronic device based on responses from the serial channel emulator disposed in the third party power adapter.

### FIELD OF THE INVENTION

The present invention is generally related to power adapters, and more specifically to power adapter serial channel emulators.

### BACKGROUND OF THE INVENTION

Many electronic device manufacturers want to control which power adapter can be used to power and/or charge their electronic devices and limit the use to a proprietary adapter that was designed and approved by the electronic device manufacturer. In an attempt to prevent third party adapters from powering and/or charging the electronic devices, some electronic device manufacturers have embedded a digital serial communication channel between their adapter and their electronic device. The digital serial communication channel is often a simple one wire data line that allows the electronic device to read or write codes into or out of the power adapter. The presence or absence of the channel and the data obtained from the power adapter will allow the electronic device to decide if the power adapter is acceptable for use.

The digital device used in the adapter for the data communication is often made exclusively for the electronic device manufacturer, thus preventing a third party from obtaining the same digital device and providing the same data to the electronic device. There is desired a means for emulating a serial channel to receive and provide the requisite information to an electronic device so that a third party adapter can be used to power and/or charge the electronic device with a power adapter serial communication channel.

### SUMMARY OF INVENTION

The present invention achieves technical advantages as a serial channel emulator. One embodiment of the invention utilizes a processing unit to emulate a serial channel in a third party power adapter by receiving data from an electronic device, such as a laptop, making decisions based upon the data, and delivering an appropriate response to the electronic device in order to allow the third party power adapter to be used. Appropriate responses can include communication initialization, serial number identification, specific stored data bytes, state of the power adapter including external indication such as Light Emitting Diodes (LEDs), confirmation of the received data, or retrieval of stored data. Once the electronic device has established communication with the power adapter and identified the appropriate response, the electronic device would allow the third party power adapter to power and/or charge the electronic device based on responses from the serial channel emulator disposed in the third party power adapter rather than the proprietary device.

### BRIEF DESCRIPTION OF THE DRAWINGS

FIG. 1 is a diagram of an implementation of a serial channel emulator integrated in a removable tip for a power adapter in accordance with an exemplary embodiment of the present invention.

FIG. 2 is a diagram of a serial channel emulator integrated into a power adapter in accordance with an exemplary embodiment of the present invention.

FIG. 3 is a diagram of a method for emulating a serial channel in a power adapter in accordance with an exemplary embodiment of the present invention.

### DETAILED DESCRIPTION OF THE PRESENT INVENTION

When a power adapter is plugged into an electronic device, such as a laptop, personal digital assistant (PDA), or gaming system, the electronic device can probe the power adapter to ensure that the power adapter is authorized to provide power to the electronic device. A power cord supplying power from the power adapter to the electronic device can contain a data line for communication between the power adapter and the electronic device as well as a power line carrying the power. Through a series of exchanges between the power adapter and the electronic device, the power adapter is either authorized or restricted from supplying power to the electronic device.

If no data line exists between the power adapter and the electronic device expecting the data line, the adapter is restricted from supplying power to the electronic device. If a serial data line does exist between the power adapter and the electronic device, the electronic device verifies that the power adapter is a manufacturer approved power adapter before allowing power to be supplied to the electronic device. The inventive concept is to use a processing unit, such as a microcontroller, to act a responding serial device so that a third party power adapter may be used to supply power to the electronic device. In one exemplary embodiment, LEDs are operably positioned in the tip to indicate charging and charge complete/power only as communicated from the laptop. The state of the LEDs is transmitted back to the laptop.

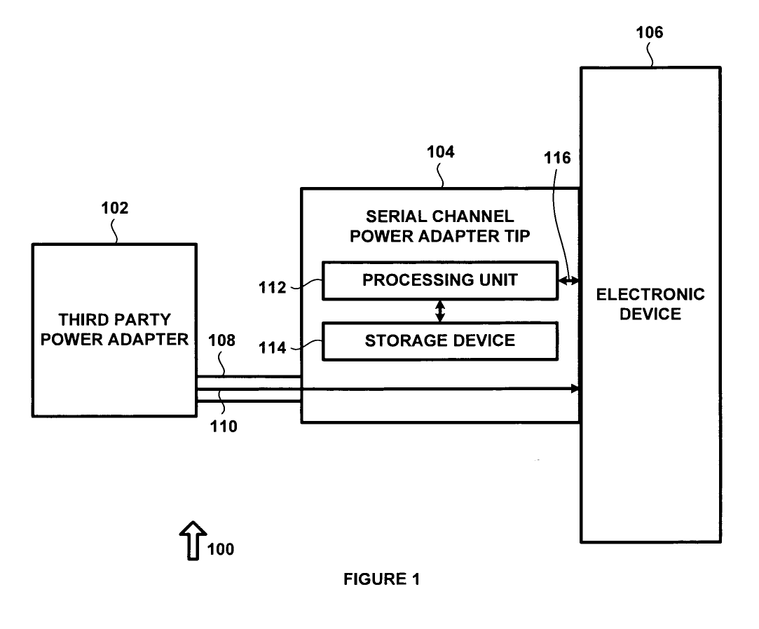

Referring to FIG. 1, there is shown at 100 a diagram of a serial channel emulator integrated in a removable tip for a power adapter in accordance with an exemplary embodiment of the present invention. Third party power adapter 102 provides power to electronic device 106 through serial channel power adapter tip 104. Serial channel power adapter tip 104 is operably coupled to power line 110, which is disposed within power cord 108, and adapted to fit securely into the power cord inlet of electronic device 106. A plurality of shapes and sizes of serial channel power adapter tip 104 exist to allow connection to a plurality of devices. Power adapter tip 104 supplies both power and data to electronic device 106.

Serial channel power adapter tip 104 includes processing unit 112 and storage device 114. Processing unit 112 is operably coupled to storage device 114 so that the data can be stored and retrieved from storage device 114. Processing unit 112 is adapted to emulate a serial channel by sending and receiving the data to and from electronic device 106. In one exemplary embodiment, processing unit 112 and storage device 114 can be combined into one device, wherein memory in the microcontroller is used to process incoming data (commands), recall data from internal memory, and transmit the data stream during communication. In a second exemplary embodiment, the data can include: communication initialization, serial number, specific stored data bytes, state of third party power adapter 102 including external indication such as Light Emitting Diodes (LEDs), or confirmation of received data. The data and a plurality of commands are stored in storage device 114. The data is sent and received through data line 116 which is operably coupled to processing unit 112 of power adapter tip 104 and electronic device 106. In a third exemplary embodiment, data line 116 can be a one wire line between processing unit 112 and electronic device 106. In a fourth exemplary embodiment, data line 116 can be a plurality of wires between processing unit 112 and electronic device 106. In a fifth exemplary embodiment, electronic device 106 can be a laptop, PDA, smartphone, mobile phone, or any electronic device requiring power. In a sixth exemplary embodiment, third party power adapter 102 is programmable.

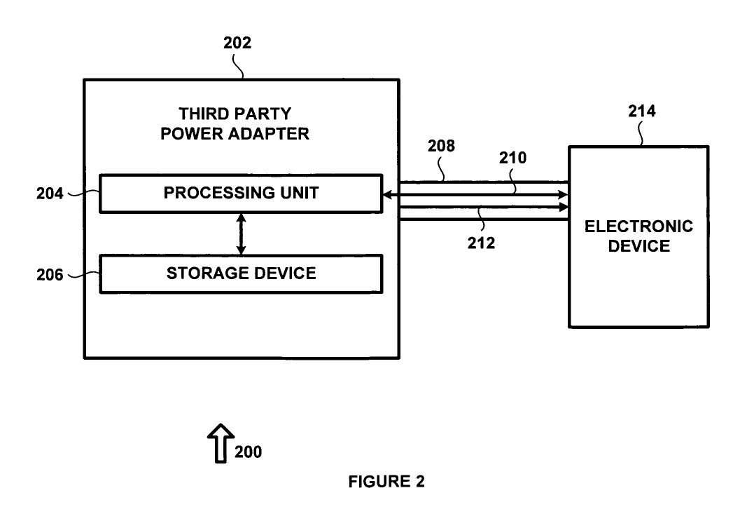

Referring now to FIG. 2, there is shown at 200 a diagram of a serial channel emulator integrated into a power adapter in accordance with an exemplary embodiment of the present invention. Third party power adapter 202 provides power to electronic device 214 through power line 212, which is operably coupled to third party power adapter 202 and electronic device 214 and disposed within power cord 208. Third party power adapter 202 includes processing unit 204 and storage device 206, which are both disposed within third party power adapter 202. Processing unit 204 is operably coupled to storage device 206 so that the data can be stored and retrieved from storage device 206. Processing unit 204 is adapted to emulate a serial channel by sending and receiving the data to and from electronic device 214.

In one exemplary embodiment, processing unit 204 and storage device 206 can be combined into one device, wherein memory in the microcontroller is used to process incoming data (commands), recall data from internal memory, and transmit the data stream during communication. In a second exemplary embodiment, the data can include: communication initialization, serial number identification, specific stored data bytes, state of third party power adapter 202 including external indication such as Light Emitting Diodes (LEDs), or confirmation of received data. The data and a plurality of commands are stored in storage device 206. The data is sent and received through data line 210 which is disposed within power cord 208 and operably coupled to processing unit 204 and electronic device 214. In a third exemplary embodiment, data line 210 can be a one wire line between processing unit 204 and electronic device 214. In a fourth exemplary embodiment, data line 210 can be a plurality of wires between processing unit 204 and electronic device 214. In a fifth exemplary embodiment, electronic device 214 can be a laptop, PDA, smartphone, mobile phone, or any electronic device requiring power. In a sixth exemplary embodiment, third party power adapter 202 is programmable.

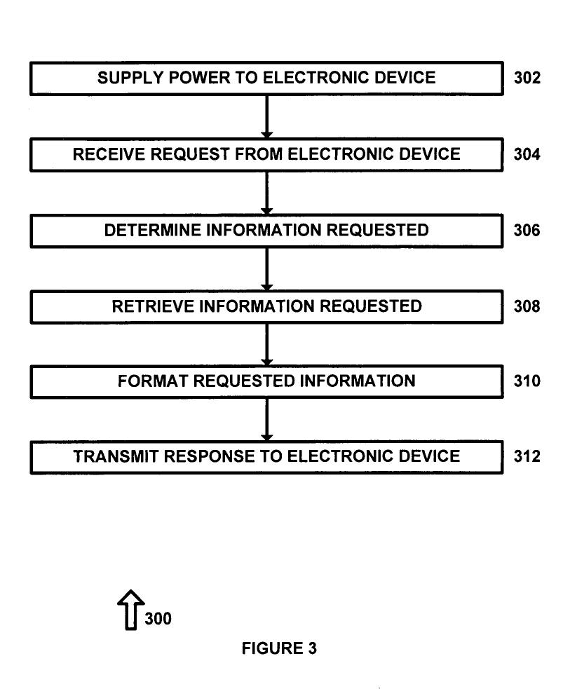

Referring now to FIG. 3, there is shown at 300 a diagram of a method for emulating a serial channel in a power adapter in accordance with an exemplary embodiment of the present invention. The method begins at 302 where power is supplied to the electronic device with a third party power adapter. In one exemplary embodiment, the third party power adapter delivers power to the electronic device, the electronic device detects the power delivery, and triggers the electronic device to attempt to authenticate the third party power adapter so it can use the third party power adapter's power. In a second exemplary embodiment, the third party power adapter is programmable. In a third exemplary embodiment, electronic device can be a laptop, PDA, smartphone, mobile phone, or any electronic device requiring power. The method then proceeds to 304.

At 304, the processing unit receives the authentication request from the device. In one exemplary embodiment, the data line exists between the electronic device and the processing unit, allowing serial communication therethrough. The method then proceeds to 306.

At 306, the processing unit determines the information requested by the device. In one exemplary embodiment, the electronic device requests a serial number in order to determine if the programmable power adapter should be authenticated. Other requested information can include: communication initialization, specific stored data bytes, state of the programmable power adapter including external indication such as Light Emitting Diodes (LEDs), or confirmation of received data. The method then proceeds to 308.

At 308, the requested information is retrieved from the storage device. The method then proceeds to 310.

At 310, the requested information is arranged into a response with an appropriate format for transmission to the electronic. In one exemplary embodiment, the response can be arranged into Recommended Standard-232 (RS-232) format. In a second exemplary embodiment, the response can be arranged into Universal Serial Bus (USB) format. The method then proceeds to 312. Additional transmission formats include Dallas Semiconductor's 1-wire protocol, LIN, and CAN.

At 312, the response is transmitted to the requesting electronic device. Once authenticated, the third party programmable power adapter can supply power to the electronic device.

The present invention derives technical advantages because first, other solutions can't provide information requested from a device in order to allow power to be supplied. The inability to provide requested information to the device results in a useless power supply, which means lost dollars and lost productivity.

The present invention achieves further technical advantages by having the capability to correctly respond to the requests of a plurality of devices. This allows a single power supply to be used with a plurality of compatible devices, which means saved time and money.

As used herein, the processing unit can include microcontrollers, discrete semiconductor devices, application-specific integrated circuits, field programmable gate arrays, general purpose processing platforms, other suitable devices, or any combination thereof.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. A serial channel emulator adapted to cooperate with a portable electronic device requiring power to operate, comprising:
a third party power adapter adapted to provide power to the portable electronic device, the third party power adapter not being authorized for use with the device by the device supplier;
a processing unit adapted, in response to a query from the electronic device, to emulate a serial channel and provide response data to the electronic device so to allow the third party power adapter to supply power to the electronic device; and
a storage device adapted to store the response data for retrieval by the processing unit.

2. The serial channel emulator of claim 1, wherein the device has a processor adapted to communicate with an authorized electronic device, wherein the processing unit is not an authorized electronic device.

3. The serial channel emulator of claim 1, wherein the processing unit is a microcontroller.

4. The serial channel emulator of claim 1, wherein the processing unit is a discrete semiconductor device.

5. The serial channel emulator of claim 1, wherein the processing unit is an application-specific integrated circuit (ASIC).

6. The serial channel emulator of claim 1, wherein the processing unit is a field programmable gate array (FPGA).

7. The serial channel emulator of claim 1, wherein the processing unit is a general purpose processing platform.

8. The serial channel emulator of claim 1, wherein the electronic device is a laptop.

9. The serial channel emulator of claim 1, wherein the electronic device is a personal digital assistant (PDA).

10. The serial channel emulator of claim 1, wherein the electronic device is a mobile phone.

11. The serial channel emulator of claim 1, wherein the electronic device is a smartphone.

12. The serial channel emulator of claim 1, wherein the electronic device is a portable music player.

13. The serial channel emulator of claim 1, wherein the electronic device is a portable video player.

14. The serial channel emulator of claim 1, wherein the electronic device is a gaming system.

15. The serial channel emulator of claim 1, wherein the power adapter is programmable.

16. A method of emulating a serial channel in a power adapter, comprising:
supplying power to a portable electronic device with a third party power adapter not authorized for use with the device by the device supplier;
receiving an authentication request from the electronic device;
determining what information is requested in the authentication request;
retrieving the information requested in the authentication request;
arranging the information requested into a response with an appropriate format for transmission to the electronic device; and
transmitting the response to the electronic device so to allow power to be supplied to the electronic device by the third party power adapter.

17. The method of claim 16, wherein the information requested is that required to initialize communication.

18. The method of claim 16, wherein the information requested is a serial number.

19. The method of claim 16, wherein the information requested is specific stored data bytes.

20. The method of claim 16, wherein the information is arranged into Recommended Standard-232 (RS-232) format.

21. The method of claim 16, wherein the information is arranged into Universal Serial Bus (USB) format.

22. The method of claim 16, wherein the information requested is confirmation of received data.

23. The method of claim 16, wherein the information requested is the programmable power adapter state.
